(19) United States
(12) Patent Application Publication
(10) Pub. No.: US 2012/0161408 A1
(43) Pub. Date: Jun. 28, 2012

(54) Baby Carry On

(76) Inventor: Guravtar Sidhu, San Marcos, CA (US)

(21) Appl. No.: 13/335,876

(22) Filed: Dec. 22, 2011

Related U.S. Application Data
(60) Provisional application No. 61/426,329, filed on Dec. 22, 2010.

(51) Int. Cl. B62B 3/08

(52) U.S. Cl. 280/47.38

(57) ABSTRACT

A piece of luggage adapted for travel with children that includes a carry-on sized suitcase with pock mounted, contoured child seat with a safety restraint. One or more pockets are thermally insulated to beverages, and one or more pockets are removable to facilitate diaper and clothing changes.

### CROSS-REFERENCES

The present application claims the benefit of U.S. Provisional Patent Application with the Ser. No. 61/426,329 (filed Dec. 22, 2010), which is incorporated by reference herein.

### BACKGROUND OF THE INVENTION

Commercial air travel has become an important part of the global economy, and for many, an expected convenience of modern life. The Research and Innovative Technology Administration (RITA) of the Bureau of Transportation Statistics (BTS) reports that in 2009 there were over 10 million commercial fights in the U.S. carrying approximately 767 million passengers. The Federal Aviation Administration (FAA) forecasts that the number of passengers carried by U.S. commercial airlines will reach one billion per year by 2015. Los Angeles International Airport (LAX) alone accommodated over 53 million passenger arrivals and departures in 2009.

The high volume Of air passenger traffic, ridged timing of commercial flights and extensive security screening procedures at airports create high levels of stress for air travelers. This is especially true for those traveling with children. In the course of a commercial flight, parents and guardians must protect the children in their care as well as attend to their needs. Children are at risk of becoming lost or injured, cannot walk the long distances required in air terminals, and require specialized supplies for their care, comfort, and maintenance.

Commercial airlines impose limitations on the number, type, and size of items passengers can take on flights. The major U.S. commercial air carriers including: United®, Delta®, U.S. Airways®, and Continental® uniformly limit the dimensions of carry-on luggage to 22 inches tall, 14 inches wide, and 9 inches deep. Passengers exceeding these limitations by traveling with too many items or items that are too large can be subject to additional fees. However, exceptions are often made for strollers, child car seats, and child restraint systems.

### SUMMARY OF THE INVENTION

Described herein is a piece of luggage adapted for travel with children. In one embodiment, the overall size and shape of the luggage is predominantly defined by a suitcase 1 that further defines an interior compartment and includes a means of providing access to the interior compartment. The suitcase 1 has dimensions of 18-25 inches high, 15-21 inches wide, and 7-13 inches deep. The luggage includes a plurality of pockets 3,5 accessible from the exterior of the luggage. Each pocket optionally includes a means of reversibly closing the pocket, thus reversibly providing access to its interior 4,6. One or more pockets are more thermally insulated than the other pockets and one or more pockets are removable. The luggage further includes a collapsible handle 7 adapted for gripping with the hand, a bottom surface including one or more rollers 13 adapted to facilitate moving the luggage by rolling, and a top surface including a contoured seat cavity 8 adapted for contact with a child's body and a means of restraining a child 11 sitting in the contoured seat cavity.

In some embodiments, the luggage described herein includes a fold-out support means 14 adapted to contact the ground to prevent the luggage from toppling. In further embodiments, the fold-out support means includes non-skid feet 15. In further embodiments, the fold-out support means includes one or more additional supports 16 to increase stability and prevent overextension.

### BRIEF DESCRIPTION OF THE DRAWINGS

FIG. 1 shows a frontal view of the luggage described herein in a stowable configuration with the collapsible handle 7 collapsed.

FIG. 2 shows a frontal view of the luggage described herein in a stowable configuration with the collapsible handle 7 with a back support 12 extended with the restraining means deployed in a position for receiving a child.

FIG. 3 shows a frontal view of the luggage described herein in a stowable configuration with the collapsible handle 7 with a back support 12 extended and a child strapped in a sitting position and confined with the restraining means.

FIG. 4 shows a side view of the luggage described herein in a rollable configuration with the collapsible handle 7 with back support 12 extended and the means of restraining a child 11 deployed.

FIG. 5 shows a frontal view of the luggage described herein in a stationary configuration demonstating a fold-out front panel with the collapsible handle 7 in a collasped state.

FIG. 6 is a perspective view of the collapsible handle 7 with back support 12 having a straight position, in a lay-back position 7a and a laying position 7b.

### DETAILED DESCRIPTION OF THE INVENTION

We have identified a long felt and unmet need for luggage that can be carried onto a commercial flight that helps relieve the stress that parents and guardians experience in the course of travel with children. Thus, a primary objective of the luggage described herein is to provide a novel option for securing and transporting children that helps parents and guardians protect and comfort the children in their care in the course of travel. Another objective of the luggage described herein is to provide storage space tailored to the needs of parents, guardians, and children in the course of travel; namely, one or more thermally insulated pockets for food and beverage storage and one or more removable pockets for diapers, wipes, and clothing. Additional objectives of the luggage described herein include reducing the number of items a parent or guardian must travel with and helping parents and guardians avoid extra luggage fees by integrating a suitcase with a stroller and a child seat.

### Certain Definitions

The term “child” means a human aged 3 months to 6 years.

The term “parent” includes birth parents, step parents, adoptive parents, and foster parents.

The term “guardian” includes blood relatives of a child, legal relatives of a child, babysitters, nannies, au pairs, employees of the child's relatives, friends of the child or the child's relatives, and those not listed but entrusted with the care of a child.

### Piece of Luggage

Described herein is a piece of luggage, adapted for travel with children. In one embodiment, the piece of luggage includes a suitcase 1 that defines an interior compartment and includes a means of providing access to the interior compartment. The suitcase 1 is optionally hard-sided or soft-sided. The suitcase 1 is made of materials known to those of skill in the art including, by way of non-limiting examples, plastics (e.g., nylon, polyester, rubber, polystyrene, polyvinyl chloride, polycarbonate, polypropylene, polyurethane, and polyethylene), cotton, Kevlar®, Cordura®, leather, neoprene, steel, aluminum, carbon fiber, and fiber glass, or a combination thereof using techniques known to those of skill in the art.

The interior of the suitcase is accessed by means known to those of skill in the art including, by way of non-limiting examples, zippers, hook-and-loop closures, laces, drawstrings, snaps, clips, straps, and buckles, or a combination thereof. In some embodiments, the interior compartment is a single space. In other embodiments, the interior compartment is further divided into sub-compartments.

In one embodiment, the piece of luggage includes a suitcase 1 that has dimensions of: 19-25 inches high, 15-21 inches wide, and 7-13 inches deep. In some embodiments, the luggage is adapted for air travel with children and meets the requirements for carry-on luggage of substantially all major U.S. commercial airlines. In further embodiments, the luggage is adapted for non-air travel with children including, by way of non-limiting examples, automobile travel, train travel, bus travel, subway travel, and ship travel.

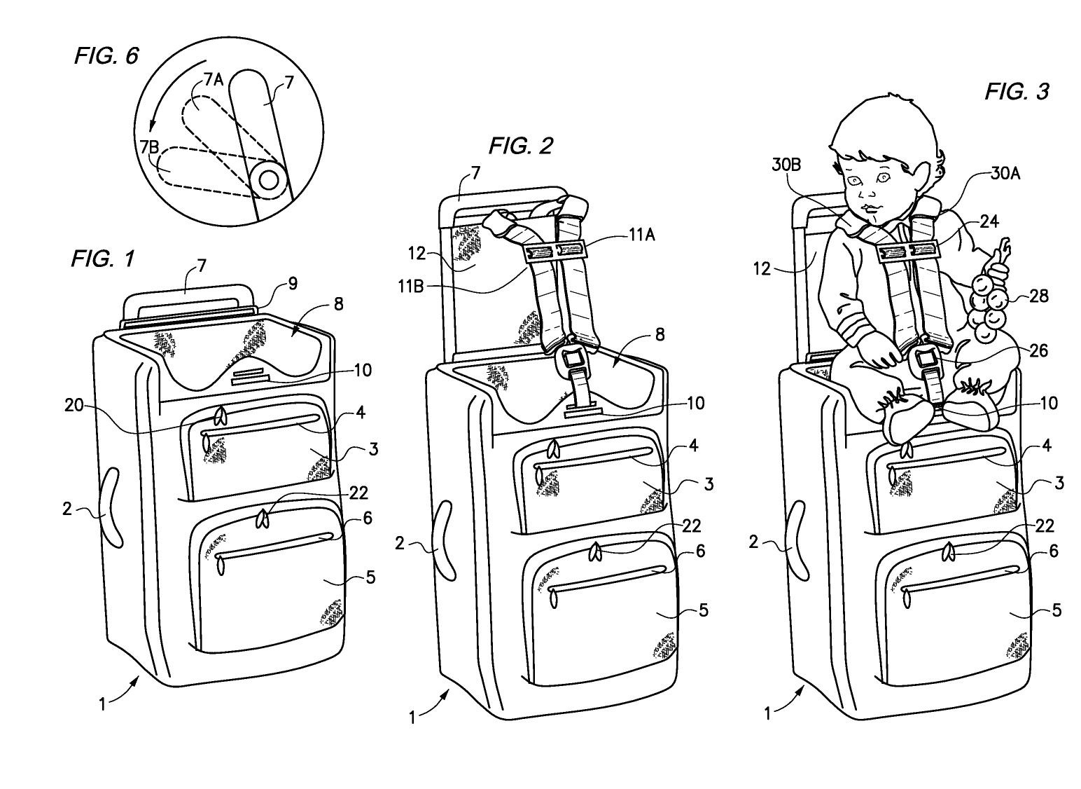

Referring to FIG. 1, in some embodiments, the luggage includes a suitcase 1 that is substantially 22 inches high, 17.7 inches wide, and 9.8 inches deep. With the collapsible handle 7 collapsed and the fold-out support means 14 retracted, the luggage meets the requirements of substantially all major U.S. commercial airlines for carry-on luggage and is stowable in the overhead storage bin of a commercial aircraft. The luggage has a side handle 2 and a child seat 8 located on the top. Also shown in this FIG. 1 is a belt connector 10 with a release button.

In some embodiments, the luggage described herein further includes a fixed handle 2 attached to the suitcase 1. The fixed handle 2 is adapted for carrying and lifting the luggage and made of made of materials known to those of skill in the art using techniques known to those of skill in the art.

### Ouside Pockets

The luggage described herein includes a plurality of pockets 3, 5 accessible from the exterior of the suitcase 1. Each pocket optionally includes a means of reversibly closing the pocket, thus reversibly providing access to its interior 4, 6. The pockets are accessed by means known to those of skill in the art including, by way of non-limiting examples, zippers, hook-and-loop closures, laces, drawstrings, snaps, clips, straps, buckles, and magnets, or a combination thereof.

The luggage described herein includes one or more pockets in the plurality of pockets accessible from the exterior of the suitcase that are more thermally insulated than the others and adapted to maintain the temperature of food, medicine, milk, or other beverages. In some embodiments, the luggage described herein includes one pocket that is more thermally insulated than the others. In other embodiments, the luggage described herein includes two, three, or four pockets that are more thermally insulated than others.

The luggage described herein includes one or more pockets in the plurality of pockets accessible from the exterior of the suitcase that are removable and adapted to facilitate transporting diapers, wipes, and clothing to a location away from the luggage suitable for cleaning a child, changing a child's diaper, or changing a child's clothing. In some embodiments, the luggage described herein includes one pocket that is removable. In other embodiments, the luggage described herein includes two, three, or four pockets that are removable.

### Collapsible Handle

The luggage described herein includes a collapsible handle 7 adapted for gripping with the human hand. The collapsible handle 7 is made of materials known to those of skill in the art using techniques known to those of skill in the art.

Referring to FIG. 1, the collapsible handle 7 can be pushed into a collapsed configuration to facilitate stowing in confined spaces, including by way of non-limiting examples, the trunk of a vehicle or the overhead storage bin of an aircraft.

Referring to FIG. 2 and FIG. 3, the collapsible handle 7 can be pulled into an extended configuration to facilitate rolling the luggage. In the extended configuration, the collapsible handle 7 facilitates the seating of a child (with a toy in hand 28) in the child seat 8 by providing a back support 12 and an right harness belt 11a having a padding means 30b and and left harness belt 11b having a 30b desigened for the means of restraining a child 18. Also shown in FIG. 2 and more specifically in FIG. 3 shows a restraining clasp 24 and a connector buckle 26.

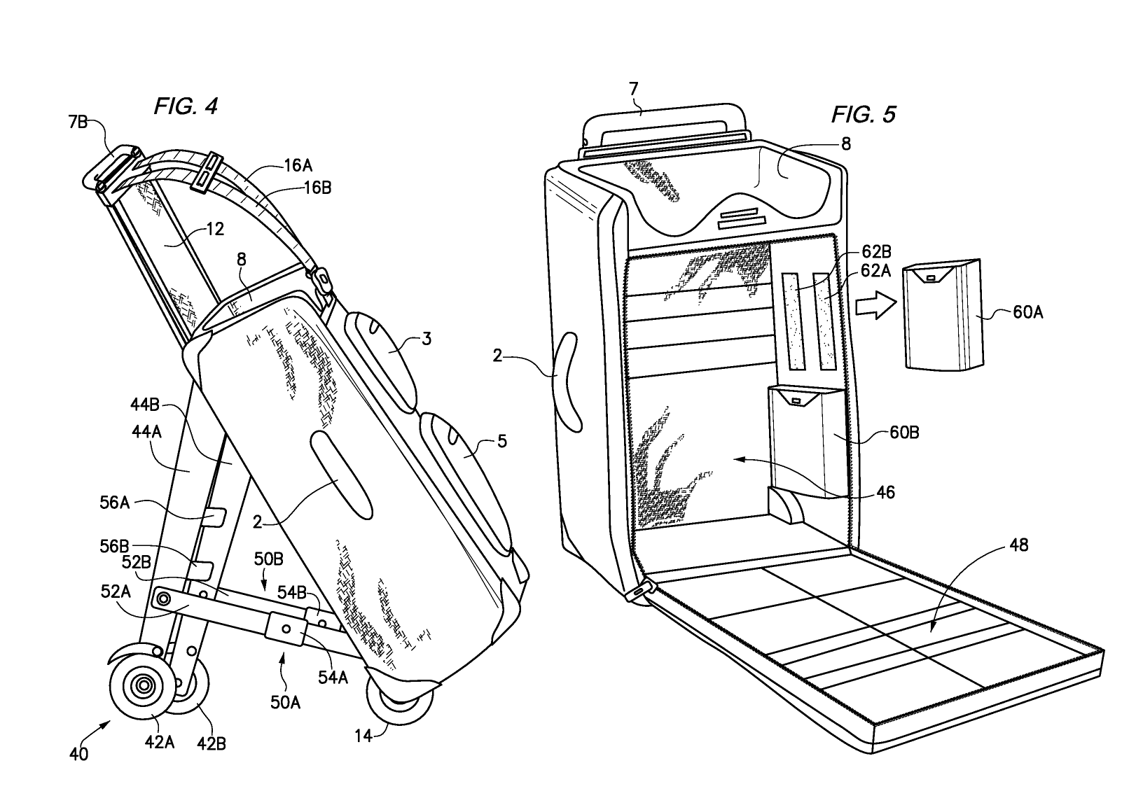

Referring to FIG. 6, the collapsible handle 7 can be pulled into an extended configuration to facilitate rolling the luggage. In the extended configuration, the collapsible handle 7 can have a mechanism that allows the extended configuration to be in a straight position, in a lay-back position 7a and a laying position 7b.

The back support 12 is made of materials known to those of skill in the art using techniques known to those of skill in the art. In some embodiments, the back support 12 is made of a soft, crushable material. in other embodiments, the back support 12 is made of a ridged material.

### Rollers

Referring to FIG. 4, the luggage described herein includes one or more rollers 14, 42a and 42b on the bottom surface adapted to facilitate moving the luggage by rolling. In some embodiments, the luggage includes one wide roller positioned along an edge of the bottom surface. In other embodiments, the luggage includes two rollers, three rollers, four rollers, five rollers, or six rollers. In some embodiments, the rollers employ bearings to facilitate motion around an axle. In other embodiments, the rollers employ bushings to facilitate motion around an axle. The rollers are made of made of materials known to those of skill in the art including, by way of non-limiting examples, nylon, polyester, rubber, polystyrene, polyvinyl chloride, polypropylene, polyurethane, and polyethylene, or a combination thereof using techniques known to those of skill in the art.

### Baby Seat

The luggage described herein includes a molded seat cavity 8 on the top surface adapted for contact with a human child's body. The contoured seat cavity 8 is made of materials known to those of skill in the art including, by way of non-limiting examples, nylon, polyester, rubber, polystyrene, polyvinyl chloride, polypropylene, polyethylene, cotton, and neoprene, or combinations thereof using techniques known to those of skill in the art.

In some embodiments, the contoured seat cavity 8 is permanently affixed to the top surface of the luggage. In some embodiments, the contoured seat cavity 8 further includes a removable fabric cover.

The luggage described herein includes a means of restraining 11 a child sitting in the contoured seat cavity 8. The means of restraining 11 a child is made of materials known to those of skill in the art including, by way of non-limiting examples, cotton, nylon, polyester, leather, and neoprene, or combinations thereof using techniques known to those of skill in the art.

In some embodiments, the means of restraining 11 a child is a two-point lap-style seat belt. In some embodiments, the means of restraining 11 a child is a three-point harness-style seat belt. In other embodiments, the means of restraining 11 a child is a five-point harness-style seat belt.

In some embodiments, the means of restraining 11 a child attaches to the luggage at one or more attachment points 9 on the collapsible handle 7. In some embodiments, the means of restraining 11 a child attaches to the luggage at one or more attachment points 10 on the molded seat cavity 8.

### Fold-out Support Means

Referring to FIG. 4, the luggage described herein optionally includes a fold-out support means 40 adapted to contact the ground to prevent the luggage from toppling by expanding the base of support for the luggage. The fold-out support means 40 includes a right fold-out support means 44a and a left fold-out support means 44b, which is attached to the suitcase 1 on each proximal end and engaged to a right folding mechanism 50a and a left folding mechanism 50b near the distal end. The right fold-out support means 44a and a left fold-out support means 44b can include an upper additional support bracket 56a and a lower additional support bracket 56b. The right folding mechanism 50a and a left folding mechanism 50b consists of a right proximal support bracket 52a and a left proximal support bracket 52b, a right folding buckle 54a and a left folding buckle 54b and a right distal support bracket and a left distal support bracket which are attached to the suitcase 1. Attached to the distal end of the right fold-out support means 44a and a left fold-out support means 44b are two or more rollers 42a and 42b that can include a brake mechanism. Also shown in this figure are one or more rollers 14 engaged to the bottom front area of the suitcase 1. The fold-out support means 40 is made of made of materials known to those of skill in the art including, by way of non-limiting examples, plastic, aluminum, steel, fiber glass, and carbon fiber, or a combination thereof using techniques known to those of skill in the art. The rollers are made of made of materials known to those of skill in the art including, by way of non-limiting examples, nylon, polyester, rubber, polystyrene, polyvinyl chloride, polypropylene, polyurethane, and polyethylene, or a combination thereof using techniques known to those of skill in the art.

In some embodiments, the fold-out support means includes one or more non-skid feet 15 made of non-skid materials known to those of skill in the art using techniques known to those of skill in the art.

In some embodiments, the fold-out support means includes one or more additional supports 16 connecting the fold-out support 14 to the luggage. In further embodiments, the one or more additional supports .16 are adapted to provide increased stability to prevent the luggage from toppling. In still further embodiments, the one or more additional supports 16 are adapted to prevent overextension of the fold-out support 14. The one or more additional supports 16 are made of made of materials known to those of skill in the art including, by way of non-limiting examples, plastic, aluminum, steel, fiber glass, and carbon fiber, or a combination thereof using techniques known to those of skill in the art. In some embodiments, the one or more additional supports 16 are rigid and hinged.

### Inside Pockets

Referring to FIG. 5, tof the luggage described herein includes a folding out door 48 that opens the interior space 46 of the suitcase 1. The interior space 46 of the suitcase 1 can include an upper inside pocket 60a that is attached to one side of the suitcase using a removable upper first upper attachment means 62a and a second upper attachment means 62b. The luggage can also have one or more lower inside pocket 60b. The removable attached means are known to those of skill in the art including, by way of non-limiting examples, zippers, hook-and-loop closures, drawstrings, snaps, clips, straps, buckles, and magnets, or a combination thereof. The inside pockets can be more thermally insulated to maintain the temperature of food, medicine, milk, or other beverages. In some embodiments, the luggage described herein includes one pocket that is more thermally insulated than the others. In other embodiments, the luggage described herein includes two, three, or four pockets that are more thermally insulated than others. The inside pockets can be adapted to facilitate transporting diapers, wipes, and clothing to a location away from the luggage suitable for cleaning a child, changing a child's diaper, or changing a child's clothing.

### EXAMPLES

The following illustrative examples are representative embodiments of the luggage adapted for travel with children described herein and are not meant to be limiting in any way.

### Example 1

### Stowable Configuration

FIG. 1 depicts one embodiment of the luggage adapted for travel with children described herein in a stowable configuration. The luggage includes a suitcase 1 that defines an interior compartment and includes a means of providing access to the interior compartment. The suitcase 1 is soft-sided and made of Cordura®. The interior compartment of the suitcase is accessed with a plastic zipper. The suitcase 1 includes a fixed handle 2 adapted for carrying and lifting the luggage. The fixed handle is made of folded and stitched Cordura® riveted to the suitcase 1 using techniques known to those of skill in the art.

Referring to FIG. 1, the luggage includes two pockets accessible from the exterior of the suitcase. The upper pocket 3 includes a means of reversibly closing the pocket, thus reversibly providing access to its interior. The interior of the upper pocket is accessed with a plastic zipper 4. The upper pocket 3 is attached to the suitcase 1 with hook-and-loop fastener material and is removable from the suitcase. The lower pocket 5 includes a means of reversibly closing the pocket, thus reversibly providing access to its interior. The interior of the lower pocket is accessed with a plastic zipper 6. The lower pocket 5 is more thermally insulated than the upper pocket and is adapted to store foods, medicines, milk, and other beverages that preferably stay cool or foods and beverages that preferably stay warm. The luggage includes a collapsible/extensible handle 7 adapted for gripping with the human hand. The collapsible/extensible handle 7 is collapsed. The luggage includes a contoured seat cavity 8 integrated into the top surface of the suitcase 1. The contoured seat cavity 8 is adapted for contact with a human child's body and is made of polypropylene using techniques known to those of skill in the art.

In the stowable configuration depicted in FIG. 1, the luggage is substantially 22 inches high, 17.7 inches wide, and 9.8 inches deep and meets the requirements of substantially all major U.S. commercial airlines for carry-on luggage. To use the luggage in the stowable configuration a traveler places the luggage in the overhead storage bin of a commercial aircraft or the trunk of a vehicle. The traveler may remove the removable upper pocket 3 to facilitate changing a child's diaper or clothing during travel.

### Example 2

### Deployed and Rollable Configuration

Referring to FIGS. 2 and 3, the luggage adapted for travel with children described in FIG. 1 is in a rollable configuration. The collapsible/extensible handle 7 is extended. The collapsible handle 7 facilitates moving the luggage by rolling. In the extended configuration, the collapsible handle 7 facilitates the seating of a child (with a toy in hand 28) in the child seat 8 by providing a back support 12 and an right harness belt 11a having a padding means 30b and and left harness belt 11b having a 30b desigened for the means of restraining a child 18. Also shown in FIG. 2 and more specifically in FIG. 3 shows a restraining clasp 24 and a connector buckle 26. The means of restraining 11a nd 11b a child is made of polyester webbing using techniques known to those of skill in the art. The luggage further includes a pluarity of rollers 14, 42a and 42b (see FIG. 4) attached to opposite sides of the bottom surface of the suitcase 1. The rollers 14, 42a and 42b are adapted to facilitate moving the luggage by rolling and are made of polyurethane using techniques known to those of skill in the art.

To use the luggage in the deployed and rollable configuration depicted in FIG. 2, the traveler grips the collapsible/extensible handle 7, tilts the luggage onto the rollers 14, 42a and 42b, and moves the luggage by rolling. The traveler may seat a child in the contoured seat cavity 8 and use the means of restraining 11a and 11b to a keep the child attached to luggage. The child rests against the back support 12 and may enjoy a warm or cool snack from the lower thermally insulated pocket 5.

What is claimed is:

1. An article of manufacture, adapted for travel with children, comprising:
(a) a piece of luggage that defines an interior compartment and includes a means of providing access to the interior compartment, wherein said piece of luggage has dimensions of: 19-25 inches high, 15-21 inches wide, and 7-13 inches deep;
(b) a plurality of pockets accessible from the exterior of the luggage, wherein each pocket in said plurality of pockets includes a means of providing access to its interior; wherein one or more pockets in said plurality of pockets is more thermally insulated than the others; wherein one or more pockets in said plurality of pockets is removable; wherein one or more pockets are optionally reversibly closable;
(c) a collapsible/extensible handle adapted for gripping with a human hand;
(d) a bottom surface including one or more rollers adapted to facilitate moving the luggage by rolling;
(e) a top surface including a contoured seat cavity adapted for contact with a human child's body and a means of restraining a child sitting in said cavity;
(f) optionally, a fold-out support means adapted to contact the ground to prevent said luggage from toppling or for use to rolling the luggage.

2. The article of manufacture of claim 1, wherein the piece of luggage is selected from a suitcase, a briefcase, a computer case, a backpack, a trunk, a tote bag, a chest, and a Gladstone bag.

3. The article of manufacture of claim 2, wherein the piece of luggage is a suitcase.

4. The article of manufacture of claim 1, wherein the piece of luggage is substantially 22 inches high, 17.7 inches wide, and 9.8 inches deep.

5. The article of manufacture of claim 1, wherein the piece of luggage includes an interior compartment adapted for holding a personal computing device.

6. The article of manufacture of claim 1, wherein one or more pockets are optionally reversibly closable by means of a zipper, a snap, hook-and-loop closure, or a combination thereof.

7. The article of manufacture of claim 1, wherein the plurality of pockets comprises 2-6 pockets.

8. The article of manufacture of claim 1, wherein one pocket is more thermally insulated than the others.

9. The article of manufacture of claim 1, wherein two, three, or four pockets are more thermally insulated than the others.

10. The article of manufacture of claim 1, wherein one pocket is removable.

11. The article of manufacture of claim I, wherein two, three, or four pockets are removable.

12. The article of manufacture of claim 1, wherein one or more pockets are adapted for holding a mobile phone.

13. The article of manufacture of claim 1, wherein one or more pockets are adapted for holding a personal computing device.

14. The article of manufacture of claim 1, including two, three, or four rollers.

15. The article of manufacture of claim 14, wherein the rollers swivel with respect to the luggage.

16. The article of manufacture of claim 1, including two rollers.

17. The article of manufacture of claim 1, wherein the means of restraining a child is a two-point lap-style seat belt, a three-point harness-style seat belt, or a five-point harness-style seat belt.

18. The article of manufacture of claim 17, wherein the means of restraining a child is substantially made of nylon webbing.

19. The article of manufacture of claim 1, wherein the means of restraining a child is a three-point harness-style seat belt.

20. The article of manufacture of claim 1, wherein the contoured seat cavity further includes a removable cover.

21. The article of manufacture of claim 1, including a fold-out support means, wherein the fold-out support means further includes non-skid feet.

22. The article of manufacture of claim 1, including a fold-out support means, wherein the fold-out support means further includes one or more additional supports connecting said fold-out support to said luggage.
